(19) United States
(12) Patent Application Publication
(10) Pub. No.: US 2023/0306313 A1
(43) Pub. Date: Sep. 28, 2023

(54) KNOWLEDGE TRANSFER IN COLLABORATIVE LEARNING

(71) Applicant: Microsoft Technology Licensing, LLC, Redmond, WA (US)

(72) Inventors: Dimitrios Basile DIMITRIADIS, Bellevue, WA (US); Antonio Andre MONTEIRO MANOEL, Sao Paulo (BR); Robert Alexander SIM, Bellevue, WA (US); Yae Jee CHO, Pittsburgh, PA (US)

(21) Appl. No.: 17/701,650

(22) Filed: Mar. 22, 2022

(51) Int. Cl. G06N 20/20; H04L 67/10

(52) U.S. Cl. CPC G06N 20/20; H04L 67/10

(57) ABSTRACT

Examples of ensemble knowledge transfer in collaborative learning include: receiving, at a primary node, from a plurality of remote nodes, a plurality of trained proxy machine learning (ML) models, wherein each proxy ML model is received from a different one of the plurality of remote nodes, and wherein each of the plurality of remote nodes is remote across a network from the primary node; training a primary ML model using the plurality of proxy ML models, wherein training the primary ML model comprises: for each of a plurality of training cases of a primary training dataset, weighting results from each of the proxy ML models based on at least a confidence of the respective proxy ML model regarding the training case.

### BACKGROUND

Federated learning (FL) is a privacy-friendly solution for training machine learning (ML) models, in which a plurality of edge-device nodes (clients), such as cellular user devices or internet of things (IoT) devices, participate in collaborative learning - without disclosing their data. The datasets used for training on each edge-device node, which may contain user data such as speech samples or imagery, remains on the node, and is used to locally train an ML model. The locally-trained ML model is then sent to an aggregating server for transferring the learned knowledge, for example using matched averaging or aggregation with locally-trained ML models from other nodes. FL may be used when using a labeled training dataset for traditional ML training is undesirable, due to cost and/or privacy concerns.

Unfortunately, these approaches require that the ML models have identical architectures. Resource limitations (e.g., memory and processing power) on the clients preclude the training of large ML models on clients, thereby rendering large ML model architectures and some ML architectures unsuitable for FL, even on the aggregating server (which may not have the same resource limitations).

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Examples of ensemble knowledge transfer in collaborative learning include: receiving, at a primary node, from a plurality of remote nodes, a plurality of trained proxy machine learning (ML) models (an ensemble of proxy ML models), wherein each proxy ML model is received from a different one of the plurality of remote nodes, and wherein each of the plurality of remote nodes is remote across a network from the primary node; training a primary ML model using the plurality of proxy ML models, wherein training the primary ML model comprises: for each of a plurality of training cases of a primary training dataset, weighting results from each of the proxy ML models based on at least a confidence of the respective proxy ML model regarding the training case.

### BRIEF DESCRIPTION OF THE DRAWINGS

The disclosed examples are described in detail below with reference to the accompanying drawing figures listed below:

FIG. 1 illustrates an example arrangement that advantageously provides ensemble knowledge transfer in collaborative learning;

FIG. 2 illustrates the movement of proxy machine learning (ML) models and knowledge in the arrangement of FIG. 1;

FIG. 3 show a flowchart illustrating exemplary operations associated with the arrangement of FIG. 1;

FIG. 4 shows another flowchart illustrating exemplary operations associated with the arrangement of FIG. 1; and

FIG. 5 is a block diagram of an example computing environment suitable for implementing some of the various examples disclosed herein.

Corresponding reference characters indicate corresponding parts throughout the drawings.

### DETAILED DESCRIPTION

The various examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

Examples of ensemble knowledge transfer in collaborative learning include: receiving, at a primary node, from a plurality of remote nodes, a plurality of trained proxy machine learning (ML) models (an ensemble of proxy ML models), wherein each proxy ML model is received from a different one of the plurality of remote nodes, and wherein each of the plurality of remote nodes is remote across a network from the primary node; training a primary ML model using the plurality of proxy ML models, wherein training the primary ML model comprises: for each of a plurality of training cases of a primary training dataset, weighting results from each of the proxy ML models based on at least a confidence of the respective proxy ML model regarding the training case.

Aspects of the disclosure improve the operations of computing devices by enabling unsupervised training of a primary ML model with an unlabeled dataset, by distilling knowledge from proxy ML models that may be of different architectures - and which is able to leverage datasets on remote nodes without exposing those datasets to the primary ML model or exposing the primary ML model to any of the remote nodes. This capability is able to significantly drive down the cost of training large primary ML models, preserve the privacy of datasets at the remote nodes (e.g., user devices), while providing robust training.

Aspects of the disclosure leverage weighted consensus to achieve the above-identified advantages by, for each of a plurality of training cases of a primary training dataset, weighting results from each of the proxy ML models based on at least a confidence of the respective proxy ML model regarding the training case. Aspects of the disclosure further leverage diversity regularization, in which proxy ML models that do not follow a consensus of the plurality of proxy ML models also transfer representations to the primary ML model. This further improves the performance of the primary ML model. Aspects of the disclosure further permit the use of a larger and different architecture for the primary ML model than is used for the proxy ML models, which enables smaller ML models to execute on the remote nodes while providing enhanced performance for the primary ML model. This advantageous operation, along with the advantageous use of (less expensive, more readily-available) unlabeled training data is facilitated by the use of a weighted consensus-based distillation scheme.

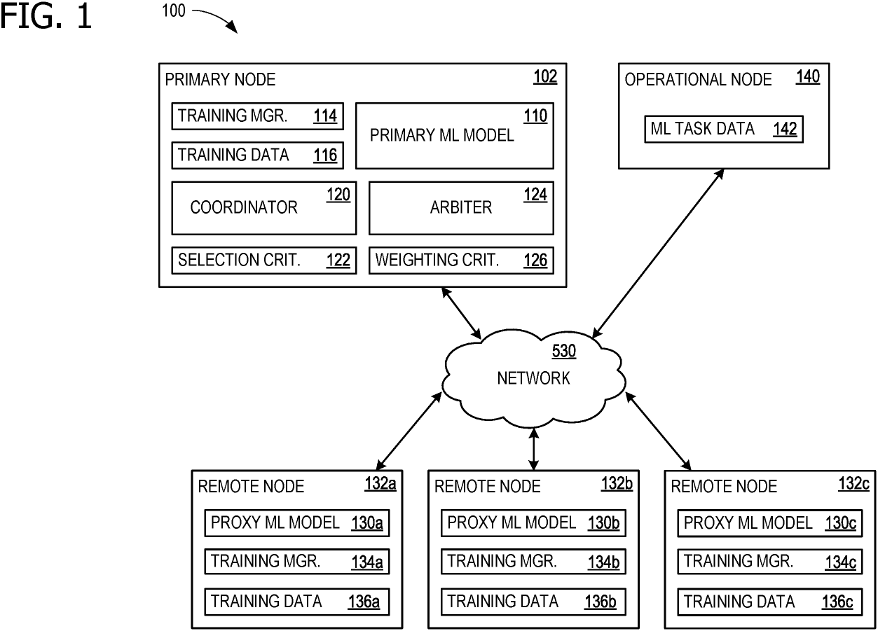

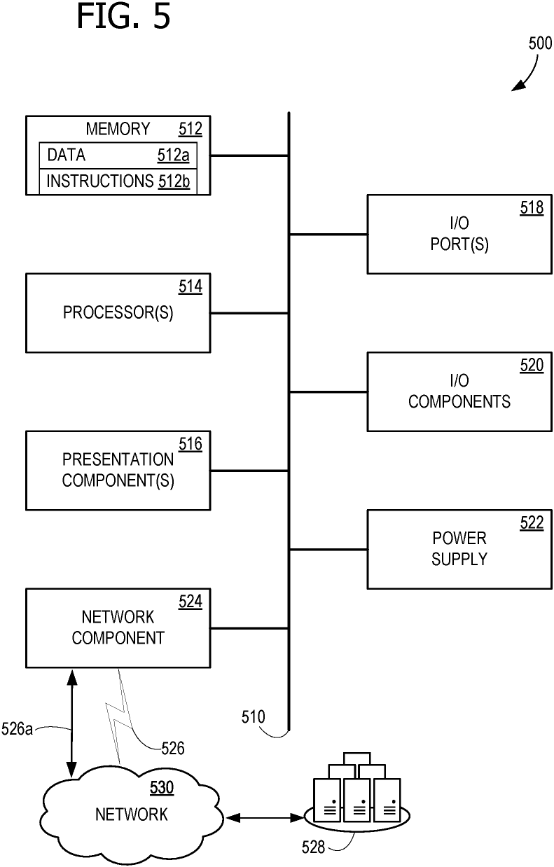

FIG. 1 illustrates an example arrangement 100 that advantageously provides ensemble knowledge transfer in collaborative learning. In some examples, arrangement 100 is implemented using examples of computing device 500 of FIG. 5. For example, each of a primary node 102, a remote node 132a, a remote node 132b, a remote node 132c, an operational node 140, and a network 530 may comprise one or more computing devices 500. Although only three remote nodes 132a-132c and three proxy ML models 130a0130c are illustrated, it should be understood that the number of remote nodes and proxy ML models may be significantly larger, for example numbering in the thousands.

A primary ML model 110 is to be trained to perform an ML task on ML task data 142, when deployed on operational node 140. The ML task may be image classification, object detection or recognition, speech recognition, language classification, or another task. ML task data 142 may be image, video, or audio data, or another type of data. Training of primary ML model 110 is performed on primary node 102 by a primary training manager 114, using a primary training dataset 116. The training may be unsupervised. Primary training dataset 116 may include or be entirely unlabeled training cases, and may be considered to be a public dataset. Primary training manager 114 may also provide initial training of proxy ML models 130a-130c.

After initial training, proxy ML models 130a-130c are trained on a respective one of remote nodes 132a-132c. For example, proxy ML model 130a may be trained on remote node 132a by a local training manager 134a, using local training dataset 136a; proxy ML model 130b may be trained on remote node 132b by a local training manager 134b, using local training dataset 136b; and proxy ML model 130c may be trained on remote node 132c by a local training manager 134c, using local training dataset 136c. Client-side training (e.g. training at remote nodes 134a-134c) may be supervised or unsupervised. Training datasets 136a-136c may be labeled or unlabeled.

In some examples, remote nodes 132a-132c may be user devices, and training datasets 136a-136c may contain data for which privacy is a concern. Arrangement 100 does not require disclosure of any of training datasets 136a-136c outside of their respective remote nodes 132a-132c, in order for primary ML model 110 to benefit from the content of training datasets 136a-136c. This enhances the privacy of users of remote nodes 132a-132c.

A coordinator 120 selects a remote node for each of proxy ML models 130a-130c, deploys proxy ML models 130a-130c across network 530 on the selected remote node for training, and later retrieves proxy ML models 130a-130c for training primary ML model 110. Deployment, retrieval, and training may iterate to improve the performance of primary ML model 110. Proxy ML models 130a-130c and primary ML model 110 rotate among student and teacher roles when distilling knowledge. In a student-teacher training technique, the teacher is trained first, and then is used to train the student.

Here, proxy ML models 130a-130c are trained remotely, possibly using labeled training data, and then retrieved to be teachers to primary ML model 110 in the role of the student. Training cases from primary training dataset 116 are provided to the ensemble of proxy ML models 130a-130c, and the output results are used to teach primary ML model 110. Because the output of pre-trained proxy ML models 130a-130c is used as what primary ML model 110 should output, there is no need for the training cases from primary training dataset 116 to be labeled.

Coordinator 120 may select the remote nodes randomly, or use selection criteria 122 that includes model architecture information, training history (to diversify training of each proxy ML model among differing remote nodes), remote node dataset type, remote node dataset size, and other criteria. Different ML architectures, which is a possibility with arrangement 100, and/or different data distributions result in different behaviors.

When distilling knowledge from proxy ML models 130a-130c to primary Ml model 110, proxy ML models 130a-130c each report a confidence level, in addition to a result on a training case. This confidence may be based on a distribution of logits or an indep algorithm. For a proxy ML model, if logits have a sharp peak, then confidence is high, whereas if logits are spread, confidence will be low. Consensus among plurality of proxy ML models 130a-130c is weighted by at least this confidence.

In some examples, an arbiter 124 scores each of proxy ML models 130a-130c and assigns an external weight to the output of a proxy ML model (in addition to a weight based on each proxy ML model’s self-reported confidence). Arbiter 124 uses weighting criteria 126 to determine weights for the various ones of proxy ML models 130a-130c, which may include training history information that indicates which of proxy ML models 130a-130c have received more training or training on a larger number of different ones of remote nodes 132a-132c.

After primary ML model 110 has been trained by proxy ML models 130a-130c, primary ML model 110 will have the benefit of the aggregate knowledge of proxy ML models 130a-130c, whereas (after only the initial round), each of proxy ML models 130a-130c will have only the knowledge it received individually, from its training history. Thus, primary ML model 110 is likely to have the benefit of more comprehensive training than the individual ones of proxy ML models 130a-130c. At this point the student-teacher training roles swap, and training cases from primary training dataset 116 are provided to primary ML model 110. The output of primary ML model 110 is now used to further train each of proxy ML models 130a-130c. In some examples, both training primary ML model 110 by proxy ML models 130a-130c and also training proxy ML models 130a-130c by primary ML model 110 comprise transfer learning.

Transfer learning is an ML process that focuses on storing knowledge gained while solving one problem and applying it to a different, but related problem. For example, proxy ML models 130a-130c gain knowledge from solving problems in training datasets 136a-136c on remote nodes 132a-132c, under the direction of local training managers 134a. They then solve related problems in primary training dataset 116 on primary node 102, along with primary ML model 110, under the direction of primary training manager 114. Primary training manager 114 uses the results from proxy ML models 130a-130c as what primary ML model 110 needs to learn.

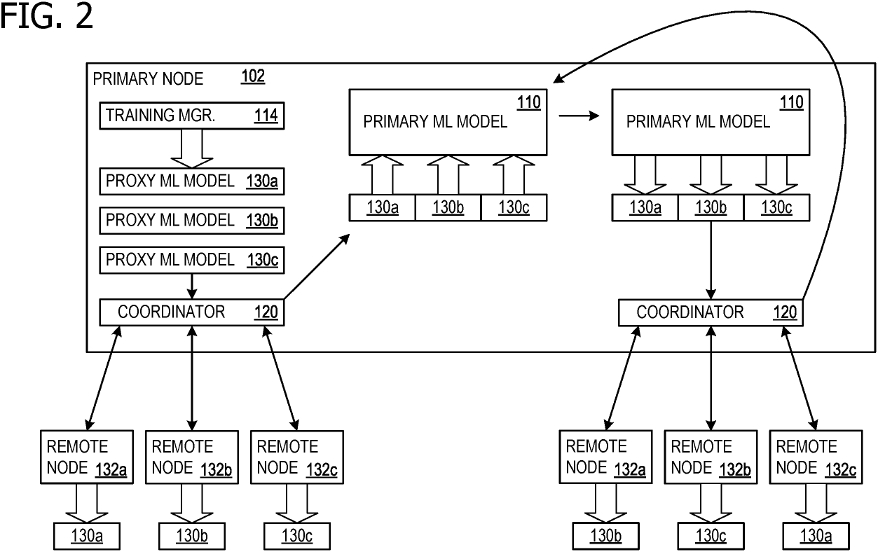

FIG. 2 illustrates the movement of proxy ML models and knowledge in arrangement 100. On primary node 102, training manager 114 provides initial training to proxy ML models 130a-130c. Coordinator 120 assigns each of proxy ML models 130a-130c to a respective one of remote nodes 132a-132c, and deploys them, where they are each trained using one of local training datasets 136a-136c. Coordinator 120 then retrieves each of proxy ML models 130a-130c back to primary node 102.

Training manager 114 distills knowledge from proxy ML models 130a-130c into primary ML model 110, as described below. Primary ML model 110 has now been trained in a least a first round of training. However, additional rounds of training may be leveraged. In preparation for redeploying proxy ML models 130a-130c for further training, training manager 114 distills the combined knowledge of primary ML model 110 into proxy ML models 130a-130c. Proxy ML models 130a-130c now likely have superior training and performance than at the time of their initial deployment.

Coordinator 120 assigns each of proxy ML models 130a-130c to a respective one of remote nodes 132a-132c, and redeploys them, where they are each trained using one of local training datasets 136a-136c. In some examples, the assignment of a proxy ML model to a remote node is at least partially random. In some example, coordinator 120 attempts to diversify the training, such that each of proxy ML models 130a-130c is likely to be deployed to a different one of remote nodes 132a-132c on second and subsequent deployments. As illustrated, in this second deployment, proxy ML model 130a is deployed to remote node 132c, proxy ML model 130b is deployed to remote node 132a, and proxy ML model 130c is deployed to remote node 132b. Coordinator 120 then retrieves each of proxy ML models 130a-130c back to primary node 102 for the next round of training primary ML model 110. This loop may iterate as needed.

Arrangement 100 provides an ensemble knowledge transfer framework that trains primary ML model 110 with smaller and heterogeneous models (in some examples) that are trained on clients (remote nodes 132a-132c), using primary training dataset 116 (an unlabeled public dataset, in some examples). Three consecutive steps are used, as shown in FIG. 2, and may be iterated: (1) clients local training and representation transfer, (2) weighted consensus distillation with diversity regularization, and (3) server representation transfer.

A cross-device setup, which may involve Federated learning (FL) in some examples, with an N-class classification task where K clients are connected to a server (e.g., primary node 102), is used. Each client k∈[K] has its local training dataset Bₖ and each data sample ξ is a pair (x, y) with input x∈ ℝ^{d} and label yE[1,N]. Each client has its local objective

$${F}_{k} \left(w\right) = \frac{1}{\left|{B}_{k}\right|} {\sum }_{ξ ∈ {B}_{k}} f \left(w , ξ\right)$$

with f(w,ξ) being the composite loss function. Having a large w with identical architecture across all resource-constrained clients, as done in the standard FL framework, may be infeasible. Moreover, the local minimums

$${w}_{k}^{*} ,$$

k∈[1,K] minimizing Fₖ(w) can be different from each other due to data-heterogeneity. These obstacles are overcome by training a large server model with a data-aware ensemble transfer from the smaller models trained on clients.

For U small and heterogeneous models at the server with M = {1 : w̅₁, ..., U : w̅_{U}}, where M is the hashmap with the keys 1, ..., U as model identifiers, the values M [i] = w̅ᵢ ∈ ℝⁿⁱ as the models, and nᵢ as the number of parameters for i∈[U]. The heterogeneous models are not necessarily od the same architecture as each other or the primary model being trained at the server. All of the small models in M have a representation layer hᵢ ∈ℝ^{U},i∈[U], which includes the classification layer, connected to the end of their different model architectures u<<nᵢ; i∈[U]. Each client is designated by its model to use from M depending on its resource capability. With slight customization of notation, the model identifier chosen by client k is denoted as M(k)∈[1;U], and the local model for that client k∈[K] as wₖ = w̅_{M(k)} = M[M(k)], which has its respective representation layer defined as hₖ.

The server has its global model defined as w̅ ∈ ℝⁿ also with its representation layer defined as h̅ ∈ ℝ^{u}. The server model is assumed to be much larger than the models in M, (i.e., n>>nᵢ; i∈[U]). As shown below, the representation layers h̅, hₖ, k∈[K] are shared bidirectionally between clients and server to transfer the representations learned from their respective training. Only the server has access to an unlabeled public dataset denoted as P. The local models wₖ, k∈[K], and server model w̅ output soft-decisions (logits) over the predefined number of classes N, which is a probability vector over the N classes. The soft-decision of model wₖ over any input data x in either the private or public dataset is S(wₖ, x). ℝ^{nM(k)}× (Bₖ ∪ P) → Δ_{N}, where Δ_{N} stands for the probability simplex over N.

Step 1: Client Local Training & Representation Transfer. For each communication round t, the server gets the set of m<K clients, denoted as S^{(t,0)}, by selecting them in proportion to their dataset size. The upper-subscript (t,r) denotes the t^{th} communication round and r^{th} local iteration. Note that S^{(t,0)} is independent of the local iteration index. For each client kES^{(t,0)}, the most recent version of its designated model

$${w}_{k}^{\left(t , 0\right)} = {\overline{w}}_{M \left(\text{k}\right)}^{\left(\text{t} , 0\right)} =$$

M[M(k)] is sent from the server to the client. The clients perform local mini-batch stochastic-gradient descent (SGD) steps on their local model

$${w}_{k}^{\left(t , 0\right)}$$

with their private dataset Bₖ, k∈[K]. Accordingly, the clients k∈S^{(t,0)} perform local updates so that for every communication round their local models are updated as:

$${w}_{k}^{\left(t , r\right)} = {w}_{k}^{\left(t , 0\right)} = - \frac{η t}{b} {\sum }_{r = 0}^{r - 1} {\sum }_{ξ ∈ {ξ}_{k}^{\left(t , r\right)}} ∇ f \left({w}_{k}^{\left(t , r\right)} , ξ\right) \qquad \text{Eq. (1)}$$

where ηₜ is the learning rate and

$$\frac{1}{b} {\sum }_{r = 0}^{r - 1} {\sum }_{ξ ∈ {ξ}_{k}^{\left(t , r\right)}} ∇ f \left({w}_{k}^{\left(t , r\right)} , ξ\right)$$

is the stochastic gradient over mini-batch

$${ξ}_{k}^{\left(t , r\right)}$$

of size b randomly sampled from Bₖ. After the clients

$$k ∈ {\text{S}}^{\left(\text{t} , 0\right)}$$

finish their local updates, the models

$${w}_{k}^{\left(t , r\right)} ,$$

k∈S^{(t,0)} are sent to the server. Each client has different representation layers

$${h}_{k}^{\left(t , r\right)}$$

in their respective models

$${w}_{k}^{\left(t , r\right)} ,$$

k∈S^{(t,0)}. The server receives these models from the clients and updates its representation layer with the ensemble models as

$${\overline{h}}^{\left(t , 0\right)} = \frac{1}{m} {\sum }_{k ∈ {S}^{\left(t , 0\right)}} {h}_{k}^{\left(t , r\right)} .$$

This pre-conditions the server model with the clients’ representations for Step 2 where the server model is trained with the ensemble loss.

Step 2: Ensemble Loss by Weighted Consensus with Diversity Regularization. Next, the server model is trained via a weighted consensus-based knowledge distillation scheme from the small models received from the clients. A key characteristic of this ensemble is that each model may be trained on data samples from different data distributions. Therefore, some clients may be more confident than others on each of the public data samples. However, all clients may still have useful representations to transfer to the server, even when they are not very confident about that particular data sample. Thus, a weighted consensus distillation scheme with diversity regularization is employed, where the server model is trained on the consensus knowledge from the ensemble of models while regularized by the clients that do not follow the consensus.

Weighted Consensus: A reliable consensus is derived over the ensemble of models by evaluating the variance within the logit vectors

$$s \left({w}_{k}^{\left(t , r\right)} , x\right) , \text{x} ∈ P$$

for each client

$$k ∈ {\text{S}}^{\left(\text{t} , 0\right)} .$$

This variance is denoted as

$${σ}_{s}^{2} \left({w}_{k}^{\left(t , r\right)} , x\right) : = V a r \left(s \left({w}_{k}^{\left(t , r\right)} , x\right)\right) ,$$

which is the variance taken over the N total probability values for the N-multi-class classification task. Higher

$${σ}_{s}^{2} \left({w}_{k}^{\left(t , r\right)} , x\right)$$

indicates higher confidence, i.e., a more confident client k about how well it models data sample x, and the reverse. Thus, the logits from the clients with high

$${σ}_{s}^{2} \left({w}_{k}^{\left(t , r\right)} , x\right)$$

are weighted more heavily than low-variance logit clients. A confidence based weighted average over the logits is set for each data sample x∈P denoted as:

$${s}^{\left(t , r\right)} \left(x\right) = {\sum }_{k ∈ {S}^{\left(t , 0\right)}} {α}_{k}^{\left(t , r\right)} \left(x\right) s \left({w}_{k}^{\left(t , r\right)} , x\right) \qquad \text{Eq. (2)}$$

where the weights are defined as:

$${α}_{k}^{\left(t , r\right)} \left(x\right) = \frac{{σ}_{s}^{2} \left({w}_{k}^{\left(t , r\right)} , x\right)}{{\sum }_{l ∈ {S}^{\left(t , 0\right)}} {σ}_{s}^{2} \left({w}_{l}^{\left(t , r\right)} , x\right)} \qquad \text{Eq. (3)}$$

The resulting weighted consensus logit

$${\text{s}}^{\left(t , r\right)} \left(\text{x}\right)$$

efficiently derives the consensus out of the ensemble of models trained on heterogeneous datasets, due to filtering out the following two main adversaries: (1) the non-experts with low intravariance within each logit, and (2) overly-confident but erroneous outliers by utilizing the power of ensemble where multiple experts contribute to the consensus.

For each data sample x, the most probable label from

$${\text{s}}^{\left(t , r\right)} \left(\text{x}\right)$$

is:

$${y}_{s}^{\left(t , r\right)} \left(x\right) = a r g m a {x}_{l a b e l ∈ \left[0 , N - 1\right]} {s}^{\left(t , r\right)} \left(x\right) \qquad \text{Eq. (4)}$$

The pair

$$\left(\text{x} , {y}_{s}^{\left(t , r\right)} , \left(x\right)\right) , \text{x} ∈ P$$

is the consensus-derived data sample from the unlabeled public dataset P, which is then used to train the server model with the cross-entropy loss

$$l \left(\left(x , {y}_{s}^{\left(t , r\right)} , \left(x\right)\right) , {\overline{w}}^{\left(t , 0\right)}\right) .$$

The cross-entropy loss term used in the final ensemble loss for training the server model is:

$$\frac{1}{\left|{B}_{k}\right|} {\sum }_{x ∈ P} l \left(\left(x , {y}_{s}^{\left(t , r\right)} , \left(x\right)\right) , {\overline{w}}^{\left(t , 0\right)}\right) \qquad \text{Eq. (5)}$$

Diversity Regularization: While the confidence based weighted consensus can derive a more reliable consensus from the ensemble, the diversity across the participating models is less represented. Meaningful representation information of what clients learned from their private data may be included, in some examples, even when certain clients have low confidence and may have different logits from the consensus. Encouraging diversity across models can improve the generalization performance of ensemble learning. Thus, the logits are gathered from the clients that do not coincide with the consensus:

$${S}_{d i v}^{\left(t , 0\right)} \left(x\right) = \left\{\begin{matrix}l : {y}_{s}^{\left(t , r\right)} \left(x\right) \neq a r g m a {x}_{l a b e l ∈ \left[0 , N - 1\right]} s \left({w}_{l}^{\left(t , r\right)} , x\right) \\ ∩ l ∈ {S}^{\left(t , 0\right)}\end{matrix}\right\} \qquad \text{Eq. (6)}$$

and formulate a regularization term:

$${s}_{d i v}^{\left(t , r\right)} \left(x\right) = {\sum }_{k ∈ {S}_{d i v}^{\left(t , 0\right)}} α \left({w}_{k}^{\left(t , r\right)} , x\right) s \left({w}_{k}^{\left(t , r\right)} , x\right) \qquad \text{Eq. (7)}$$

where the weights are

$${α}_{k} \left(x\right) = \frac{{σ}_{s}^{2} \left({w}_{k}^{\left(t , r\right)} , x\right)}{{\sum }_{l ∈ {S}^{\left(t , 0\right)}} {σ}_{s}^{2} \left({w}_{l}^{\left(t , r\right)} , x\right)} \qquad \text{Eq. (8)}$$

Accordingly, the diversity regularization term for the final ensemble loss is where KL(·,·) is the KL-divergence loss between two logits:

$$\text{KL} \left({s}_{d i v}^{\left(t , r\right)} \left(x\right) , s \left({\overline{w}}^{\left(t , 0\right)} , x\right)\right) \qquad \text{Eq. (9)}$$

Final Ensemble Loss: Finally, combining the weighted consensus based cross-entropy loss in Eq. (5) with the diversity regularization in Eq. (9), the server model is updated, in every communication round t, by minimizing the following objective function:

$$F \left({\overline{w}}^{\left(t , 0\right)}\right) = \begin{matrix}\frac{1}{\left|P\right|} {\sum }_{x ∈ P} l \left(\left(x , {y}_{s}^{\left(t , r\right)} \left(x\right)\right) , {\overline{w}}^{\left(t , 0\right)}\right) \\ + λ K L \left({s}_{d i v}^{\left(t , r\right)} \left(x\right) s \left({\overline{w}}^{\left(t , 0\right)} , x\right)\right)\end{matrix} \qquad \text{Eq. (10)}$$

To minimize the ensemble loss in Eq. (10), rather than going through the entire dataset P, the server model takes τₛ minibatch SGD steps by sampling a mini-batch

$${ξ}_{P}^{\left(t , {r}^{′}\right)} , {r}^{′} ∈ \left[0 , {τ}_{s} - 1\right]$$

of bₛ data samples from P uniformly at random, without replacement. Then, for every communication round t the server performs:

$${\overline{w}}_{k}^{\left(t , r\right)} = {\overline{w}}^{\left(t , 0\right)} - \frac{{η}_{t}}{{b}_{s}} {\sum }_{r = 0}^{r - 1} {\sum }_{ξ ∈ {ξ}_{k}^{\left(t , r\right)}} \left[\begin{matrix}∇ l \left(\left(ξ , {y}_{s}^{\left(t , r\right)} \left(ξ\right)\right) , {\overline{w}}^{\left(t , r\right)}\right) \\ + λ ∇ K L \left({s}_{d i v}^{\left(t , r\right)} \left(ξ\right) s \left({\overline{w}}^{\left(t , r\right)} , ξ\right)\right)\end{matrix}\right] \qquad \text{Eq. (11)}$$

Step 3: Model Aggregation and Server’s Representation Transfer: Finally, the server aggregates the received clients’ models based on their architecture and updates the models in M. With

$${S}_{i}^{\left(t , 0\right)} : = \left\{k : k ∈ {S}^{\left(t , 0\right)} ∩ M \left(k\right) = i\right\} ,$$

the models in M are aggregated as:

$$M \left[i\right] = {\overline{w}}_{i}^{\left(t + 1 , 0\right)} = \frac{1}{\left|{s}_{i}^{\left(t , 0\right)}\right|} {\sum }_{k ∈ {S}_{i}^{\left(t , 0\right)}} {w}_{k}^{\left(t , r\right)} , i ∈ \left[U\right] \qquad \text{Eq. (12)}$$

Since the server has been transferred the knowledge from the ensemble of models in a data-aware manner, the server has now a better representation than the clients’ models. The updated h̅^{(t,rs)} from the updated server model w̅^{(t,rs)} is therefore transferred to the models in M.

Example algorithm: The above description demonstrates component that provide federated ensemble transfer with heterogeneous models. An additional description of an algorithm is provided below:

01: Initialize: Hashmap of Heterogeneous Models:

$$M = \left\{1 : {\overline{w}}_{1}^{\left(0 , 0\right)} , … , U : {\overline{w}}_{u}^{\left(0 , 0\right)}\right\} ;$$

Designated Model Ids for each client k ∈ [K]: M(k) ∈ [1, U]; Selected set of m<K clients S^{(0,0)}.

02: Output: w̅^{(T,0)}.

03: For t = 0; ..., T-1 communication rounds do:

04: Clients k∈S^{(t,0)} in parallel do:
05: Receive
$${w}_{k}^{\left(t , 0\right)} = {\overline{w}}_{M \left(k\right)}^{\left(t , 0\right)} = \left[M \left(k\right)\right]$$
from server
06: Get
$${w}_{k}^{\left(t , r\right)}$$
from update rule (1)
07: Send updated local model
$${w}_{k}^{\left(t , r\right)}$$
to the server
08: Global server do:
09: Receive all updated local model
$${w}_{k}^{\left(t , r\right)} ,$$
k∈S(t,0)
10: Transfer clients’ representations to the server by
$${\overline{h}}^{\left(t + 1 , 0\right)} = \frac{1}{\left|{s}^{\left(t , 0\right)}\right|} {\sum }_{k ∈ {S}^{\left(t , 0\right)}} {h}_{k}^{\left(t , r\right)}$$
11: Get w̅^{(t,r}^{s)} fromfrom update rule (11)
12: Transfer server’s representation to update models in M by update rule (12)
13: Select m clients for S^{(t+1,0)} uniformly at random, without replacement in proportion to the dataset size
END.

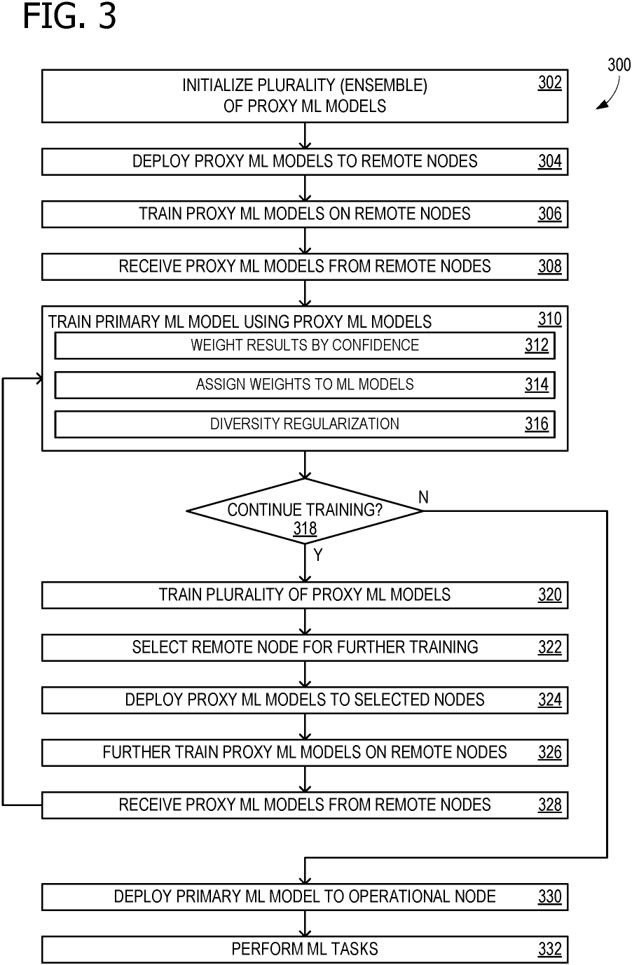

FIG. 3 shows a flowchart 300 illustrating exemplary operations associated with arrangement 100. In some examples, operations described for flowchart 300 are performed by computing device 500 of FIG. 5. Flowchart 300 commences with operation 302, which initializes plurality of proxy ML models 130a-130c with initial training. In some examples, at least two of proxy ML models 130a-130c have different architectures from each other (e.g., plurality of proxy ML models 130a-130c may be heterogeneous). In some examples, at least one of proxy ML models 130a-130c has a different architecture than primary ML model 110.

Operation 304 deploys plurality of proxy ML models 130a-130c to plurality of remote nodes 132a-132c. In some examples, at least one node of plurality of remote nodes 132a-132c comprises a user device. In some examples, each node of plurality of remote nodes 132a-132c comprises a user device. Operation 306 trains each of plurality of proxy ML models 130a-130c on its respective remote node.

Operation 308 includes receiving, at primary node 102, from plurality of remote nodes 132a-132c, plurality of trained proxy ML models 130a-130c. Each proxy ML model is received from a different one of plurality of remote nodes 132a-132c, and each of plurality of remote nodes 132a-132c is remote across network 530 from primary node 102.

Operation 310 trains primary ML model 110 using plurality of proxy ML models 130a-130c, with primary ML model 110 in the role of student and plurality of proxy ML models 130a-130c (the ensemble) in the role of teachers. The training of primary ML model 110 is performed with a weighted consensus-based distillation scheme, as described above. Training primary ML model 110 comprises, for each of the plurality of training cases of the training dataset, determining a weighted consensus of plurality of proxy ML models 130a-130c. In some examples, primary training dataset 116 comprises unlabeled training cases (e.g., the primary training dataset is unlabeled). In some cases one or more, or even each of the plurality of training cases is unlabeled. In some examples, training primary ML model 110 comprises unsupervised training. Operation 310 is performed using one or more of operations 310-316.

Operation 312 weights results from each of proxy ML models 130a-130c for each of a plurality of training cases of primary training dataset 116, based on at least a confidence of the respective proxy ML model regarding the training case. Proxy ML models having higher confidence are weighted more heavily than proxy ML models having less confidence. In some examples, weighting results from each of proxy ML models 130a-130c comprises further weighting the results from each of proxy ML models 130a-130c based on at least a score assigned to each of proxy ML models 130a-130c by arbiter 124 in operation 314. In some examples, training primary ML model 110 comprises diversity regularization in operation 316. In diversity regularization, proxy ML models that do not follow a consensus of plurality of proxy ML models 130a-130c also transfer representations to primary ML model 110, but with lesser weight.

Decision operation 318 determines whether to continue the training of primary ML model 110 with additional stages, or deploy primary ML model 110 for operation. If additional training is selected, operation 320 trains each of proxy ML models 130a-130c with (now trained) primary ML model 110. The student and teacher roles are swapped, with primary ML model 110 in the role of teacher and plurality of proxy ML models 130a-130c (the ensemble) in the role of students.

Operation 322 selects from among plurality of remote nodes 132a-132c for further training of plurality of proxy ML models 130a-130c. In some examples, the selection is random. In some examples, selecting a remote node for further training is based on at least a training history of the proxy ML model. In some examples, selecting a remote node for further training is based on at least an architecture of the proxy ML model. In some examples, selecting a remote node for further training is based on at least a dataset type at the remote node. In some examples, selecting a remote node for further training is based on at least a dataset size at the remote node.

Operation 324 deploys plurality of trained proxy ML models 130a-130c to plurality of remote nodes 132a-132c for further training. Each proxy ML model is deployed to a different one of plurality of remote nodes 132a-132c. In some examples, deploying plurality of trained proxy ML models 130a-130c for further training comprises deploying plurality of trained proxy ML models 130a-130c to the selected remote nodes. In some examples, deploying plurality of trained proxy ML models 130a-130c for further training comprises deploying plurality of trained proxy ML models 130a-130c to a random one of remote nodes 132a-132c.

Operation 326 includes receiving, at primary node 102, from plurality of remote nodes 132a-132c, (further-trained) plurality of proxy ML models 132a-132c. Operation 328 further trains primary ML model 110 using (further-trained) plurality of proxy ML models 130a-130c. Flowchart 300 then returns to operation 310.

When training is complete, operation 330 deploys trained primary ML model 110 to operational node 140. In operation 332 trained primary ML model 110 performs an ML task. In some examples, the ML task comprises image classification, object detection, object recognition, speech recognition, or language classification. In some examples, primary ML model 110 performs ML task on primary node 102, contemporaneously with ongoing training.

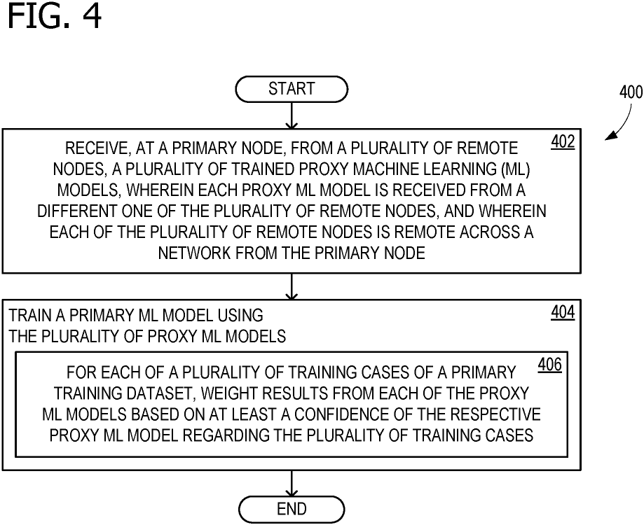

FIG. 4 shows a flowchart 400 illustrating exemplary operations associated with arrangement 100. In some examples, operations described for flowchart 400 are performed by computing device 500 of FIG. 5. Flowchart 400 commences with operation 402, which includes receiving, at a primary node, from a plurality of remote nodes, a plurality of trained proxy machine learning (ML) models, wherein each proxy ML model is received from a different one of the plurality of remote nodes, and wherein each of the plurality of remote nodes is remote across a network from the primary node.

Operation 404 includes training a primary ML model using the plurality of proxy ML models, and is performed with operation 406. Operation 406 includes, for each of a plurality of training cases of a primary training dataset, weighting results from each of the proxy ML models based on at least a confidence of the respective proxy ML model regarding the training case.

### ADDITIONAL EXAMPLES

An example system comprises: a processor; and a computer-readable medium storing instructions that are operative upon execution by the processor to: receive, at a primary node, from a plurality of remote nodes, a plurality of trained proxy ML models, wherein each proxy ML model is received from a different one of the plurality of remote nodes, and wherein each of the plurality of remote nodes is remote across a network from the primary node; and train a primary ML model using the plurality of proxy ML models, wherein training the primary ML model comprises: for each of a plurality of training cases of a primary training dataset, weighting results from each of the proxy ML models based on at least a confidence of the respective proxy ML model regarding the plurality of training cases.

An example computerized method comprises: receiving, at a primary node, from a plurality of remote nodes, a plurality of trained proxy ML models, wherein each proxy ML model is received from a different one of the plurality of remote nodes, and wherein each of the plurality of remote nodes is remote across a network from the primary node; and training a primary ML model using the plurality of proxy ML models, wherein training the primary ML model comprises: for each of a plurality of training cases of a primary training dataset, weighting results from each of the proxy ML models based on at least a confidence of the respective proxy ML model regarding the plurality of training cases.

One or more computer storage devices having computer-executable instructions stored thereon, which, upon execution by a computer, cause the computer to perform operations comprising: receiving, at a primary node, from a plurality of remote nodes, a plurality of trained proxy ML models, wherein each proxy ML model is received from a different one of the plurality of remote nodes, and wherein each of the plurality of remote nodes is remote across a network from the primary node; and training a primary ML model using the plurality of proxy ML models, wherein training the primary ML model comprises: for each of a plurality of training cases of a primary training dataset, weighting results from each of the proxy ML models based on at least a confidence of the respective proxy ML model regarding the plurality of training cases.

Alternatively, or in addition to the other examples described herein, examples include any combination of the following:
initializing the plurality of proxy ML models with initial training;
at least two of the proxy ML models have different architectures from each other;
at least one of the proxy ML models has a different architecture than the primary ML model;
deploying the plurality of proxy ML models to the plurality of remote nodes;
at least one node of the plurality of remote nodes comprises a user device;
each node of the plurality of remote nodes comprises a user device;
training each of the plurality of proxy ML models on its respective remote node;
training the primary ML model with a weighted consensus-based distillation scheme;
training the primary ML model comprises, for each of the plurality of training cases of the training dataset, determining a weighted consensus of the plurality of proxy ML models;
proxy ML models having higher confidence are weighted more heavily than proxy ML models having less confidence;
weighting results from each of the proxy ML models comprises further weighting the results from each of the proxy ML models based on at least a score assigned to each of the proxy ML models;
training the primary ML model comprises unsupervised training;
the primary training dataset comprises unlabeled training cases;
the primary training dataset is unlabeled;
each of the plurality of training cases is unlabeled;
training the primary ML model comprises diversity regularization;
proxy ML models that do not follow a consensus of the plurality of proxy ML models also transfer representations to the primary ML model;
training each of the proxy ML models with the trained primary ML model;
for each proxy ML model, selecting a remote node for further training, based on at least a training history of the proxy ML model;
for each proxy ML model, selecting a remote node for further training, based on at least an architecture of the proxy ML model;
for each proxy ML model, selecting a remote node for further training, based on at least a dataset type at the remote node;
for each proxy ML model, selecting a remote node for further training, based on at least a dataset size at the remote node;
deploying the plurality of trained proxy ML models to the plurality of remote nodes for further training, wherein each proxy ML model is deployed to a different one of the plurality of remote nodes;
deploying the plurality of trained proxy ML models for further training comprises deploying the plurality of trained proxy ML models to the selected remote nodes;
deploying the plurality of trained proxy ML models for further training comprises deploying the plurality of trained proxy ML models to a random one of the remote nodes;
receiving, at the primary node, from the plurality of remote nodes, the further-trained plurality of proxy ML models;
further training the primary ML model using the plurality of proxy ML models;
deploying the trained primary ML model to an operational node;
performing an ML task with the trained primary ML model;
the ML task comprises image classification;
the ML task comprises object recognition;
the ML task comprises speech recognition; and
the ML task comprises language classification.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 5 is a block diagram of an example computing device 500 for implementing aspects disclosed herein, and is designated generally as computing device 500. In some examples, one or more computing devices 500 are provided for an on-premises computing solution. In some examples, one or more computing devices 500 are provided as a cloud computing solution. In some examples, a combination of on-premises and cloud computing solutions are used. Computing device 500 is but one example of a suitable computing environment and is not intended to suggest any limitation as to the scope of use or functionality of the examples disclosed herein, whether used singly or as part of a larger set.

Neither should computing device 500 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 500 includes a bus 510 that directly or indirectly couples the following devices: computer storage memory 512, one or more processors 514, one or more presentation components 516, input/output (I/O) ports 518, I/O components 520, a power supply 522, and a network component 524. While computing device 500 is depicted as a seemingly single device, multiple computing devices 500 may work together and share the depicted device resources. For example, memory 512 may be distributed across multiple devices, and processor(s) 514 may be housed with different devices.

Bus 510 represents what may be one or more busses (such as an address bus, data bus, or a combination thereof). Although the various blocks of FIG. 5 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 5 and the references herein to a “computing device.” Memory 512 may take the form of the computer storage media referenced below and operatively provide storage of computer-readable instructions, data structures, program modules and other data for the computing device 500. In some examples, memory 512 stores one or more of an operating system, a universal application platform, or other program modules and program data. Memory 512 is thus able to store and access data 512a and instructions 512b that are executable by processor 514 and configured to carry out the various operations disclosed herein.

In some examples, memory 512 includes computer storage media. Memory 512 may include any quantity of memory associated with or accessible by the computing device 500. Memory 512 may be internal to the computing device 500 (as shown in FIG. 5), external to the computing device 500 (not shown), or both (not shown). Additionally, or alternatively, the memory 512 may be distributed across multiple computing devices 500, for example, in a virtualized environment in which instruction processing is carried out on multiple computing devices 500. For the purposes of this disclosure, “computer storage media,” “computer-storage memory,” “memory,” and “memory devices” are synonymous terms for the computer-storage memory 512, and none of these terms include carrier waves or propagating signaling.

Processor(s) 514 may include any quantity of processing units that read data from various entities, such as memory 512 or I/O components 520. Specifically, processor(s) 514 are programmed to execute computer-executable instructions for implementing aspects of the disclosure. The instructions may be performed by the processor, by multiple processors within the computing device 500, or by a processor external to the client computing device 500. In some examples, the processor(s) 514 are programmed to execute instructions such as those illustrated in the flow charts discussed below and depicted in the accompanying drawings. Moreover, in some examples, the processor(s) 514 represent an implementation of analog techniques to perform the operations described herein. For example, the operations may be performed by an analog client computing device 500 and/or a digital client computing device 500. Presentation component(s) 516 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 500, across a wired connection, or in other ways. I/O ports 518 allow computing device 500 to be logically coupled to other devices including I/O components 520, some of which may be built in. Example I/O components 520 include, for example but without limitation, a microphone, joystick, game pad, satellite dish, scanner, printer, wireless device, etc.

The computing device 500 may operate in a networked environment via the network component 524 using logical connections to one or more remote computers. In some examples, the network component 524 includes a network interface card and/or computer-executable instructions (e.g., a driver) for operating the network interface card. Communication between the computing device 500 and other devices may occur using any protocol or mechanism over any wired or wireless connection. In some examples, network component 524 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 524 communicates over wireless communication link 526 and/or a wired communication link 526a to a remote resource 528 (e.g., a cloud resource) across network 530. Various different examples of communication links 526 and 526a include a wireless connection, a wired connection, and/or a dedicated link, and in some examples, at least a portion is routed through the internet.

Although described in connection with an example computing device 500, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive, at a primary node, from a plurality of remote nodes, a plurality of trained proxy machine learning (ML) models, wherein each proxy ML model is received from a different one of the plurality of remote nodes, and wherein each of the plurality of remote nodes is remote across a network from the primary node; and
train a primary ML model using the plurality of proxy ML models, wherein training the primary ML model comprises:
for each of a plurality of training cases of a primary training dataset, weighting results from each of the proxy ML models based on at least a confidence of the respective proxy ML model regarding the plurality of training cases.

2. The system of claim 1, wherein the instructions are further operative to:
perform an ML task with the trained primary ML model.

3. The system of claim 1, wherein at least two of the proxy ML models have different architectures from each other and at least one of the proxy ML models has a different architecture than the primary ML model.

4. The system of claim 1, wherein the instructions are further operative to:
train each of the proxy ML models with the trained primary ML model;
deploy the plurality of trained proxy ML models to the plurality of remote nodes for further training, wherein each proxy ML model is deployed to a different one of the plurality of remote nodes;
receive, at the primary node, from the plurality of remote nodes, the further-trained plurality of proxy ML models; and
further train the primary ML model using the plurality of proxy ML models.

5. The system of claim 4, wherein the instructions are further operative to:
for each proxy ML model, select a remote node for further training, based on at least a training history of the proxy ML model, wherein deploying the plurality of trained proxy ML models for further training comprises deploying the plurality of trained proxy ML models to the selected remote nodes.

6. The system of claim 1, wherein weighting results from each of the proxy ML models comprises further weighting the results from each of the proxy ML models based on at least a score assigned to each of the proxy ML models.

7. The system of claim 1, wherein the primary training dataset comprises unlabeled training cases.

8. A computerized method comprising:
receiving, at a primary node, from a plurality of remote nodes, a plurality of trained proxy machine learning (ML) models, wherein each proxy ML model is received from a different one of the plurality of remote nodes, and wherein each of the plurality of remote nodes is remote across a network from the primary node; and
training a primary ML model using the plurality of proxy ML models, wherein training the primary ML model comprises:
for each of a plurality of training cases of a primary training dataset, weighting results from each of the proxy ML models based on at least a confidence of the respective proxy ML model regarding the plurality of training cases.

9. The method of claim 8, further comprising:
performing an ML task with the trained primary ML model.

10. The method of claim 8, wherein at least two of the proxy ML models have different architectures from each other and at least one of the proxy ML models has a different architecture than the primary ML model.

11. The method of claim 8, further comprising:
training each of the proxy ML models with the trained primary ML model;
deploying the plurality of trained proxy ML models to the plurality of remote nodes for further training, wherein each proxy ML model is deployed to a different one of the plurality of remote nodes;
receiving, at the primary node, from the plurality of remote nodes, the further-trained plurality of proxy ML models; and
further training the primary ML model using the plurality of proxy ML models, wherein training the primary ML model comprises transfer learning, and wherein further training the primary ML model comprises transfer learning.

12. The method of claim 11, further comprising:
for each proxy ML model, selecting a remote node for further training, based on at least a training history of the proxy ML model, wherein deploying the plurality of trained proxy ML models for further training comprises deploying the plurality of trained proxy ML models to the selected remote nodes.

13. The method of claim 8, wherein weighting results from each of the proxy ML models comprises further weighting the results from each of the proxy ML models based on at least a score assigned to each of the proxy ML models.

14. The method of claim 8, wherein the primary training dataset comprises unlabeled training cases.

15. One or more computer storage devices having computer-executable instructions stored thereon, which, upon execution by a computer, cause the computer to perform operations comprising:
receiving, at a primary node, from a plurality of remote nodes, a plurality of trained proxy machine learning (ML) models, wherein each proxy ML model is received from a different one of the plurality of remote nodes, and wherein each of the plurality of remote nodes is remote across a network from the primary node; and
training a primary ML model using the plurality of proxy ML models, wherein training the primary ML model comprises:
for each of a plurality of training cases of a primary training dataset, weighting results from each of the proxy ML models based on at least a confidence of the respective proxy ML model regarding the plurality of training cases.

16. The one or more computer storage devices of claim 15, wherein the operations further comprise:
performing an ML task with the trained primary ML model.

17. The one or more computer storage devices of claim 15, wherein at least two of the proxy ML models have different architectures from each other and at least one of the proxy ML models has a different architecture than the primary ML model.

18. The one or more computer storage devices of claim 15, wherein the operations further comprise:
training each of the proxy ML models with the trained primary ML model;
deploying the plurality of trained proxy ML models to the plurality of remote nodes for further training, wherein each proxy ML model is deployed to a different one of the plurality of remote nodes;
receiving, at the primary node, from the plurality of remote nodes, the further-trained plurality of proxy ML models; and
further training the primary ML model using the plurality of proxy ML models, wherein training the primary ML model comprises transfer learning, and wherein further training the primary ML model comprises transfer learning.

19. The one or more computer storage devices of claim 18, wherein the operations further comprise:
for each proxy ML model, selecting a remote node for further training, based on at least a training history of the proxy ML model, wherein deploying the plurality of trained proxy ML models for further training comprises deploying the plurality of trained proxy ML models to the selected remote nodes.

20. The one or more computer storage devices of claim 15, wherein weighting results from each of the proxy ML models comprises further weighting the results from each of the proxy ML models based on at least a score assigned to each of the proxy ML models.
